(19) United States
(12) Patent Application Publication
(10) Pub. No.: US 2005/0141551 A1
(43) Pub. Date: Jun. 30, 2005

(54) Common LAN architecture and flow control relay

(76) Inventors: Roy McNeil JR., Warwick, NY (US); Alex Cefalu, Boonton, NJ (US); Debbie Lun, Old Tappan, NJ (US)

Correspondence Address: SWIDLER BERLIN LLP, 3000 K STREET, NW, BOX IP, WASHINGTON, DC, 20007, US

(21) Appl. No.: 10/745,563

(22) Filed: Dec. 29, 2003

(51) Int. Cl. H04J 3/16; H04J 3/22; H04L 12/28

(52) U.S. Cl. 370/466; 370/401

(57) ABSTRACT

A system and method provides flow control that can be implemented for any LAN/WAN technology combination. A Local Area Network Service Unit comprises a first device having a Local Area Network interface and a second interface, the first device operable to perform MAC level operation, statistics gathering, and bridging functions, and a second device having a Wide Area Network interface and a second interface to the second interface of the first device, the device operable to perform Wide Area Network data encapsulation and decapsulation and transmit and receive buffering.

### FIELD OF THE INVENTION

The present invention relates to a system and method for rate limiting using PAUSE frame capability in a Local Area Network/Wide Area Network interface.

### BACKGROUND OF THE INVENTION

Synchronous optical network (SONET) is a standard for optical telecommunications that provides the transport infrastructure for worldwide telecommunications. SONET offers cost-effective transport both in the access area and core of the network. For instance, telephone or data switches rely on SONET transport for interconnection.

In a typical application, a local area network (LAN), such as Ethernet, is connected to a wide area network (WAN), such as that provided by SONET. This connection interface is typically provided by a device known as a LAN Service Unit (LANSU). A LANSU must perform a variety of functions. For example, must provide the interfaces with the LAN and the WAN, as well as provide flow control for data traffic flowing between the LAN and the WAN.

In order to provide the LAN interface, the LANSU must be capable of interfacing with the desired LAN technology. Conventionally, LANSUs have been designed with dedicated LAN interfaces that only handle one desired LAN technology. This results in significant development costs, since a different LANSU must be designed and produced for each LAN technology that is to be supported. In addition, if the LAN technology is replaced or upgraded, the LANSU must also be replaced. A need arises for a technique that allows a common LANSU to be used, providing cost reductions in design and production and reducing the need to replace the LANSU if the LAN technology is replaced or upgraded.

In many applications, the data bandwidth of the LAN and WAN are mismatched. For example, a common application is known as Ethernet over SONET, in which Ethernet LAN traffic is communicated using a SONET channel. The Ethernet LAN is typically 100 Base-T, which has a bandwidth of 100 mega-bits-per-second (Mbps), while the connected SONET channel may be STS-1, which has a bandwidth of 51.840 Mbps. In such an application, the peak rate of data traffic to be communicated over the WAN from the LAN may exceed the bandwidth of the WAN. In other applications, the bandwidth of the WAN may exceed the bandwidth of the LAN. In either case, a mechanism to control the flow of data between the WAN and the LAN must be provided. Flow control implementations that work for one LAN/WAN technology combination may not work for other combinations. Thus, a need arises for a technique by which flow control can be provided that can be implemented for any LAN/WAN technology combination.

### SUMMARY OF THE INVENTION

The present invention provides flow control that can be implemented for any LAN/WAN technology combination. In one embodiment of the present invention, a Local Area Network Service Unit comprises a first device having a Local Area Network interface and a second interface, the first device operable to perform MAC level operation, statistics gathering, and bridging functions, and a device having a Wide Area Network interface and a second interface to the second interface of the first device, the device operable to perform Wide Area Network data encapsulation and decapsulation and transmit and receive buffering.

In one aspect of the present invention, the Local Area Network interface comprises an Ethernet interface. The Local Area Network interface may comprise a 10/100BaseT or GigE Ethernet interface. The Service Unit may further comprise a physical layer device connected to the Local Area Network interface and operable to provide optical or electrical interfaces operating at 10/100BaseT or GigE speeds. The Wide Area Network interface may comprise a Synchronous Optical Network interface or a Synchronous Digital Hierarchy interface. The device may be operable to perform Synchronous Optical Network or Synchronous Digital Hierarchy data encapsulation and decapsulation. The device may comprise a Field Programmable Gate Array or an Application-Specific Integrated Circuit. The second interface of the first device and the second interface of the device may comprise a GMII interface. The first device may comprise a Layer 2 switch. The Layer 2 switch is placed in a port mirroring mode and is operable to provide transparency to frames except PAUSE frames. The first device may comprise a network processor.

In one aspect of the present invention, the Service Unit further comprises a transmit memory buffer and a receive memory buffer connected to the device and wherein the first device comprises an internal memory buffer. The device may be further operable to determine when the transmit memory buffer has filled to a threshold level and, in response, to transmit flow control information to the first device. The first device may be further operable to determine when the internal memory buffer has filled to a threshold level and, in response, to transmit flow control information via the Local Area Network interface. The flow control information may comprise a PAUSE frame. The PAUSE frame may have a value less than the maximum value. The Local Area Network interface may comprise an Ethernet interface. The Local Area Network interface may comprise a10/100BaseT or GigE Ethernet interface. The Service Unit may further comprise a physical layer device connected to the Local Area Network interface and operable to provide optical or electrical interfaces operating at 10/100BaseT or GigE speeds. The Wide Area Network interface may comprise a Synchronous Optical Network interface or a Synchronous Digital Hierarchy interface. The device may be operable to perform Synchronous Optical Network or Synchronous Digital Hierarchy data encapsulation and decapsulation. The device may comprise a Field Programmable Gate Array or an Application-Specific Integrated Circuit. The second interface of the first device and the second interface of the device may comprise a GMII interface. The first device may comprise a Layer 2 switch. The Layer 2 switch is placed in a port mirroring mode and is operable to provide transparency to frames except PAUSE frames. The first device may comprise a network processor.

### BRIEF DESCRIPTION OF THE DRAWINGS

FIG. 1 is an exemplary block diagram of a system in which the present invention may be implemented.

FIG. 2 is an exemplary block diagram of an optical LAN/WAN interface service unit.

FIG. 3 is an exemplary flow diagram of a process of operation of the service unit shown in FIG. 2, implementing flow control using PAUSE frames.

### DETAILED DESCRIPTION OF THE PREFERRED EMBODIMENT

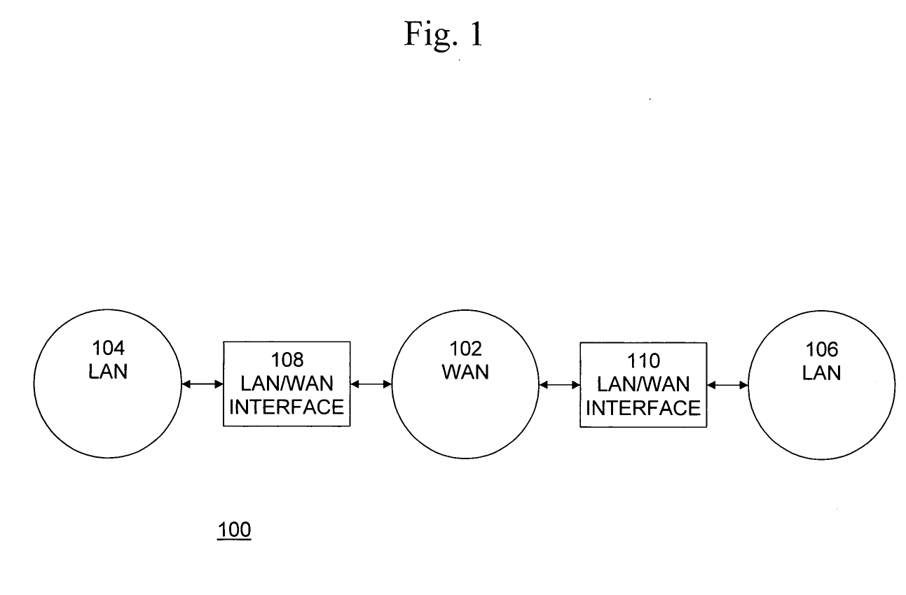

An exemplary block diagram of a system 100 in which the present invention may be implemented is shown in FIG. 1. System 100 includes a Wide Area Network 102 (WAN), one or more Local Area Networks 104 and 106 (LAN), and one or more LAN/WAN interfaces 108 and 110. A LAN, such as LANs 104 and 106, is a computer network that spans a relatively small area. Most LANs connect workstations and personal computers. Each node (individual computer) in a LAN has its own CPU with which it executes programs, but it also is able to access data and devices anywhere on the LAN. This means that many users can share expensive devices, such as laser printers, as well as data. Users can also use the LAN to communicate with each other, by sending e-mail or engaging in chat sessions.

There are many different types of LANs, Ethernets being the most common for Personal Computers (PCs). Most Apple Macintosh networks are based on Apple's AppleTalk network system, which is built into Macintosh computers.

Most LANs are confined to a single building or group of buildings. However, one LAN can be connected to other LANs over any distance via longer distance transmission technologies, such as those included in WAN 102. A WAN is a computer network that spans a relatively large geographical area. Typically, a WAN includes two or more local-area networks (LANs), as shown in FIG. 1. Computers connected to a wide-area network are often connected through public networks, such as the telephone system. They can also be connected through leased lines or satellites. The largest WAN in existence is the Internet.

Among the technologies that may be used to implement WAN 102 are optical technologies, such as Synchronous Optical Network (SONET) and Synchronous Digital Hierarchy (SDH). SONET is a standard for connecting fiber-optic transmission systems. SONET was proposed by Bellcore in the middle 1980s and is now an ANSI standard. SONET defines interface standards at the physical layer of the OSI seven-layer model. The standard defines a hierarchy of interface rates that allow data streams at different rates to be multiplexed. SONET establishes Optical Carrier (OC) levels from 51.8 Mbps (about the same as a T-3 line) to 2.48 Gbps. Prior rate standards used by different countries specified rates that were not compatible for multiplexing. With the implementation of SONET, communication carriers throughout the world can interconnect their existing digital carrier and fiber optic systems.

SDH is the international equivalent of SONET and was standardized by the International Telecommunications Union (ITU). SDH is an international standard for synchronous data transmission over fiber optic cables. SDH defines a standard rate of transmission at 155.52 Mbps, which is referred to as STS-3 at the electrical level and STM-1 for SDH. STM-1 is equivalent to SONET's Optical Carrier (OC) levels-3.

LAN/WAN interfaces 108 and 110 provide electrical, optical, logical, and format conversions to signals and data that are transmitted between a LAN, such as LANs 104 and 106, and WAN 102.

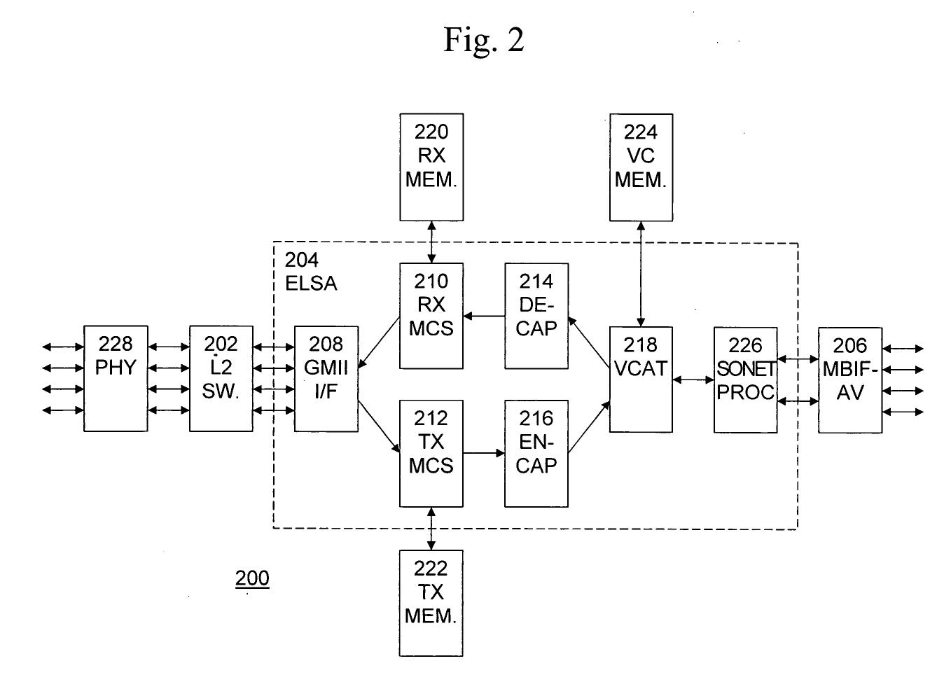

An exemplary block diagram of an optical LAN/WAN interface service unit 200 (LANSU) is shown in FIG. 2. A typical LANSU interfaces Ethernet to a SONET or SDH network. For example, a Gig/100BaseT Ethernet LANSU may provide Ethernet over SONET (EOS) services for up to 4 Gigabit Ethernet ports, (4-10/100 BaseT ports in the 100BaseT case). Each port may be mapped to a set of STS-1, STS-3c or STS-12c channels depending on bandwidth requirements. Up to 12—STS-1, 4—STS-3c or 1—STS-12c may be supported up to a maximum of STS-12 bandwidth (STS-3 with OC3 and OC12 LUs).

In addition to EOS functions, LANSU 200 may support frame encapsulation, such as GFP, X.86 and PPP in HDLC Framing. High Order Virtual Concatenation may be supported for up to 24—STS-1 or 8—STS-3c channels and is required to perform full wire speed operation on LANSU 200, when operating at 1 Gbps.

LANSU 200 includes three main functional blocks: Layer 2 Switch 202, ELSA 204 and MBIF-AV 206. ELSA 202 is further subdivided into functional blocks including a GMII interface 208 to Layer 2 (L2) Switch 202, receive Memory Control & Scheduler (MCS) 210 and transmit MCS 212, encapsulation 214 and decapsulation 216 functions (for GFP, X.86 and PPP), Virtual Concatenation 218, frame buffering provided by memories 220, 222, and 224, and SONET mapping and performance monitoring functions 226. MBIF-AV 206 is used primarily as a backplane interface device to allow 155 Mbps or 622 Mbps operation and also provides clock and data recovery circuitry. In addition LANSU 200 includes physical interface (PHY) 228.

PHY 228 provides the termination of each of the four physical Ethernet interfaces and performs clock and data recovery, data encode/decode, and baseline wander correction for the 10/100BaseT copper or 1000Base LX or SX optical. Autonegotiation is supported as follows:
10/100BaseT—speed, duplexity, PAUSE Capability
1 GigE—PAUSE Capability

PHY 228 block provides a standard GMII interface to the MAC function, which is located in L2 Switch 202.

L2 Switch 202, for purposes of transparent LAN services, is operated as a MAC device. L2 Switch 202 is placed in port mirroring mode to provide transparency to all types of Ethernet frames (except PAUSE, which is terminated by the MAC). L2 Switch 202 is broken up into four separate 2 port bi-directional MAC devices, which perform MAC level termination and statistics gathering for each set of ports. Support for Ethernet and Ether-like MIBs is provided by counters within the MAC portion of L2 Switch 202. L2 Switch 202 also provides limited buffering of frames in each direction (L2 Switch 202->ELSA 204 and ELSA 204->L2 Switch 202); however, the main packet storage area is the Tx Memory 222 and Rx Memory 220 attached to ELSA 204. L2 Switch 202 is capable of buffering 64 to 9216 byte frames in its limited memory. Both sides of L2 Switch 202 interface to adjacent blocks via a GMII interface.

L2 switch 202 can be any Layer 2 device with a GMII interface or other suitable industry standard or proprietary interface, which can be connected to the ELSA 204 to implement a LANSU. As new off-the-shelf technology emerges on the market new service units can be created without the need to modify the ELSA 204 design. In a general sense, the Common LAN Architecture consists primarily of two main devices: any generic Layer 2 switch device or network processor combined with ELSA 204. Preferably, ELSA 204 is implemented as a Field Programmable Gate Array (FPGA) or Application-Specific Integrated Circuit (ASIC). The Layer 2 device handles MAC level operation and statistics gathering as well as bridging functions. The ELSA 204 handles WAN data encapsulation and decapsulation and Tx and Rx buffering. Together, these two devices are considered the core of the architecture. In addition, physical layer devices, PHY 228, are attached as needed to provide optical or electrical interfaces operating at 10/100BaseT or GigE speeds.

ELSA 204 provides frame buffering, SONET Encapsulation and SONET processing functions.

In the Tx direction, the GMII interface 208 of ELSA 204 mimics PHY 228 operation at the physical layer. Small FIFOs are incorporated into GMII interface 208 to adapt data flow to the bursty Tx Memory 222 interface. Cut through operation is supported for data through this interface; so, for example, jumbo frames (9216 bytes) will not be stored completely in the FIFOs. Enough bandwidth is available through the GMII 208 and Tx Memory 222 interfaces (8 Gbps) to support all data transfers without frame drop for all four interfaces (especially when all four Ethernet ports are operating at 1 Gbps). The GMII interface 208 also supports the capability of flow controlling the L2 Switch 202. The GMII block 208 receives memory threshold information supplied to it from the Tx Memory Controller 212, which monitors the capacity of the Tx Memory 222 on a per port basis, and is programmable to drop incoming frames or provide PAUSE frames to the L2 Switch 202 when a predetermined threshold has been reached in memory. When flow control is used, memory thresholds are set such that no frames will be dropped. The GMII interface 208 must also calculate and add frame length information to the packet. This information is used for GFP frame encapsulation within the ELSA device.

The Tx MCS 212 provides the low level interface functions to the Tx Memory 222, as well as providing scheduler functions to control pulling data from the GMII FIFOs and paying out data to the Encapsulation block 216. For practical purposes, the Tx Memory 222 is effectively a dual port RAM; so, two independent scheduler blocks are provided for reading from and writing to the Tx Memory 222. The scheduler functions for transparent LAN services will differ slightly, but these differences will be handled through provisioning information supplied to the scheduler.

The primary function of the Tx Memory 222 is to provide a level of burst tolerance to entering LAN data, especially in the case where the LAN bandwidth is much greater than the provisioned WAN bandwidth. A secondary function of this memory is for Jumbo frame storage; this allows cut through operation in the GMII block 208 to provide for lower latency data delivery by not buffering entire large frames. The Tx Memory 222 is divided into four partitions, one for each port. Each partition is operated as an independent FIFO. Fixed memory sizes are chosen for each partition regardless of the number of ports or customers currently in operation. Partitioning in this fashion prevents dynamic re-sizing of memory when adding or deleting ports/customers and provides for hitless upgrades/downgrades. The memory is also sized independently of WAN bandwidth. This provides for a constant burst tolerance as specified from the LAN side (assuming zero drain rate on WAN side). This partitioning method also guarantees fair allocation of memory amongst customers.

The Encapsulation block 216 has a demand based interface to the Tx MCS 212. Encapsulation block 216 provides three types of SONET encapsulation modes, provisionable on a per port/customer basis (although SW may limit encapsulation choice on a per board basis). The encapsulation modes are:
PPP in HDLC framing
X.86
GFP (frame mode only)

In each encapsulation mode, additional overhead is added to the pseudo-Ethernet frame format stored in the Tx Memory 222.

The Encapsulation block 216 will decide which of the fields are relevant for the provisioned encapsulation mode. For example, Ethernet Frame Check Sequence (FCS) may or may not be used in Point-to-Point (PPP) encapsulation; and, length information is used only in GFP encapsulation. Another function of the Encapsulation block is to provide “Escape” characters to data that appears as High Level Data Link Control (HDLC) frame delineators (7Es) or HDLC Escape characters (7Ds). Character escaping is necessary in PPP and X.86 encapsulation modes. In the worst case, character escaping can nearly double the size of an incoming Ethernet frame; as such, mapping frames from the Tx Memory 222 to the SONET section of the ELSA 204 is non-deterministic in these encapsulation modes and requires a demand based access to the Tx Memory 222. An additional memory buffer block is housed in the Encapsulation block 216 to account for this rate adaptation issue. Watermarks are provided to the Tx MCS 212 to monitor when the scheduler is required to populate each port/customer space in the smaller memory buffer block.

The Virtual Concatenation (VCAT) block 218 takes the encapsulated frames and maps them to a set of pre-determined VCAT channels. A VCAT channel can consist of the following permutations:
Single STS-1
Single STS-3c
Single STS-12c
STS-1-Xv (X=1..24)
STS-3c-Xv (X=1..8)

These channel permutations provide a wide variety of bandwidth options to a customer and can be sized independently for each VCAT channel. The VCAT block 218 encodes the H4 overhead bytes required for proper operation of Virtual Concatenation. VCAT channel composition is signaled to a receive side LANSU using the H4 byte signaling format specified in the Virtual Concatenation standard. The VCAT block 218 provides TDM data to the SONET processing block after the H4 data has been added.

The SONET Processing block 226 multiplexes the TDM data from the VCAT block 218 into two STS-12 SONET data streams. Proper SONET overhead bytes are added to the data stream for frame delineation, pointer processing, error checking and signaling. The SONET Processing block 226 interfaces to the MBIF-AV block 206 through two STS-12 interfaces. In STS-3 mode (155 Mbps backplane interface), STS-3 data is replicated four times in the STS-12 data stream sent to the MBIF-AV 206; the first of four STS-3 bytes in the multiplexed STS-12 data stream represents the STS-3 data that is selected by the MBIF-AV 206 for transmission.

The MBIF-AV block 206 receives the two STS-12 interfaces previously described and maps them to the appropriate backplane interface LVDS pair. The MBIF-AV 206 also has the responsibility of syncing SONET data to the Frame Pulse provided by the Line Unit and insuring that the digital delay of data from the frame pulse to the Line Unit is within specification. The MBIF-AV 206 block also provides the capability of mapping SONET data to a 155 Mbps or 622 Mbps LVDS interface; this allows LANSU 200 to interface to the line unit subsystems with various bandwidth capabilities. 155 Mbps or 622 Mbps operation is provisionable and is upgradeable in system with a corresponding traffic hit. When operating as a 155 Mbps backplane interface, the MBIF-AV 206 must select STS-3 data out of the STS-12 stream supplied by the SONET Processing block and format that for transmission over the 155 Mbps LVDS links.

In the WAN-to-LAN datapath, MBIF-AV 206 is responsible for Clock and Data Recovery (CDR) for the four LVDS pairs, at either 155 Mbps or 622 Mbps.

The MBIF-AV 206 also contains a full SONET framing function; however, for the most part, the framing function serves as an elastic store element for clock domain transfer that is performed in this block. SONET Processing that is performed in this block is as follows:
A1, A2 alignment (provides pseudo-frame pulse to SONET Processing block to indicate start of frame)
B1 error monitoring (indicates any backplane errors that may have occurred)

Additional SONET processing is provided in the SONET Processing block 226. Multiplexing of Working/Protect channels from the standard slot interface or Bandwidth Extender slot interface is also provided in the MBIF-AV block 206. Working and Protect selection is chosen under MCU control. After the proper working/protect channels have been selected, the MBIF-AV block 206 transfers data to the SONET Processing block through one or both STS-12 interfaces. When operating at 155 Mbps, the MBIF-AV 206 has the added responsibility of multiplexing STS-3 data into an STS-12 data stream which is supplied to the SONET Processing block 226.

On the receive side, the SONET Processing block 226 is responsible for the following SONET processing:
Path Pointer Processing
Path Performance Monitoring
RDI, REI processing
Path Trace storage

In STS-3 mode of operation (155 Mbps backplane interface), a single stream of STS-3 data must be plucked from the STS-12 data stream as it enters the SONET Processing block 226. The SONET Processing block 226 selects the first of the four interleaved STS-3 bytes to reconstruct the data stream. After SONET Processing has been completed, TDM data is handed off to the VCAT block 218.

The VCAT block 218 processing is a bit more complicated on the receive side because the various STS-1 or STS-3c channels that comprise a VCAT channel may come through different paths in the network—causing varying delays between SONET channels. The H4 byte is processed by the VCAT block to determine:
STS-1 or STS-3c channel sequencing
Delays between SONET channels

This information is learned over the course of 16 SONET frames to determine how the VCAT block 218 should process the aggregate VCAT channel data. As data on each STS-1 or STS-3c is received, it is stored in VC Memory 224. Skews between each STS-1 or STS-3c are compensated for by their relative location in VC Memory 224 based on delay information supplied in the H4 information for each channel. The maximum skew between any two SONET channels is determined by the depth of the VC Memory 224. Bytes of data are spread one-by-one across each of the SONET channels that are members of a VCAT channel; so, if one SONET channel is lost, no data will be supplied through the aggregate VCAT channel.

The Decapsulation block 214 pulls data out of the VC Memory 224 based on sequencing information supplied to it by the VCAT block 218. Data is pulled a byte at a time from different address locations in VC Memory 224 corresponding to each received SONET channel that is a member of the VCAT channel. The Decapsulation block 214 is a Time Division Multiplex (TDM) block that is capable of supporting multiple instances of VCAT channels (up to 24 in the degenerate case of all STS-1 SONET channels) as well as multiple encapsulation types, simultaneously. Decapsulation of PPP in HDLC framing, X.86 and GFP (frame mode) are all supported. The Decapsulation block 214 strips all encapsulation overhead data from the received SONET data and provides raw Ethernet frames to the Rx MCS 210. If Ethernet FCS data was stripped by the transmit side Encap block 216 (option in PPP), then it is also added in the Decap block 214. Length information, used by GFP, will be stripped in this block.

Rx MCS 210 receives data from the Decapsulation block 214. The scheduling function required for populating Rx Memory 220 from the SONET side is straightforward. As the Decapsulation block 214 provides data to Rx MCS 210, it writes the corresponding data to memory 220 in the order that it was received. There is a clock domain transfer from the Decapsulation block 214 to Rx MCS 210; so, a small amount of internal buffering is provided for rate adaptation within the ELSA 204. Through provisioning information, Rx MCS 210 creates associations of VCAT channels to memory locations. Four memory partition locations are supported, one for each possible LAN port. Data in each memory partition is organized and controlled as a FIFO.

The algorithm for scheduling data from the Rx Memory 220 to corresponding LAN ports is essentially a token-based scheduling scheme. Ports/customers are given a relative number of tokens based on the bandwidth that they are allocated on the WAN side. So, an STS-3c channel is allocated three times as many tokens as an STS-1 channel. Tokens are refreshed for each port/customer on a regular basis. When the tokens reach a predetermined threshold, a port/customer is allowed to transfer data onto the appropriate LAN port. If the threshold is not reached, additional token replenishment is required before data can be sent. This algorithm takes into account the relative size of frames (byte counts) as well as the allocated WAN bandwidth for a particular port/customer. Each port/customer receives a fair share of LAN bandwidth proportional to the WAN bandwidth that was provisioned.

The scheduler function also takes into account the possibility of WAN oversubscription. Since it is possible to provision an STS-24 worth of bandwidth, care must be taken when mapping this amount of bandwidth onto a 1 Gbps LAN link; maintaining fairness of bandwidth allocation among ports/customers is key. The scheduler algorithm provides fair distribution of bandwidth under these conditions. In the case where WAN oversubscription is persistent, Rx Memory 220 will fill and eventually data will be discarded; however, it will be discarded fairly, based on the amount of memory that each port/customer was provisioned.

As with the Tx Memory 222, the Rx Memory 220 is partitioned in the same manner. Four partitions are created. Each port/customer will get an equal share of memory.

The GMII interface 208 provides the interface to the L2 switch 202 as described earlier for the Tx direction. In the Rx direction, the GMII interface 208 supplies PAUSE data as part of the data stream when the GMII has determined that watermarks were crossed in the Tx Memory 222.

The L2 Switch 202 operates the same in the Rx direction as in the Tx direction. It is completely symmetrical and uses port mirroring in this direction as well. It may receive PAUSE frames from the GMII I/F 208 in the ELSA 204, in which case, it will stop sending data to the ELSA 204. In turn, the L2 Switch 202 memory may fill (in the Tx direction) and eventually packets will be dropped, or the L2 Switch 202 will generate PAUSE to the attached router or switch. The L2 Switch 202 supplies the PHY 228 with GMII formatted data.

The PHY 228 converts the GMII information into appropriately coded information and performs a parallel to serial conversion and transfers the data out onto the respective LAN port.

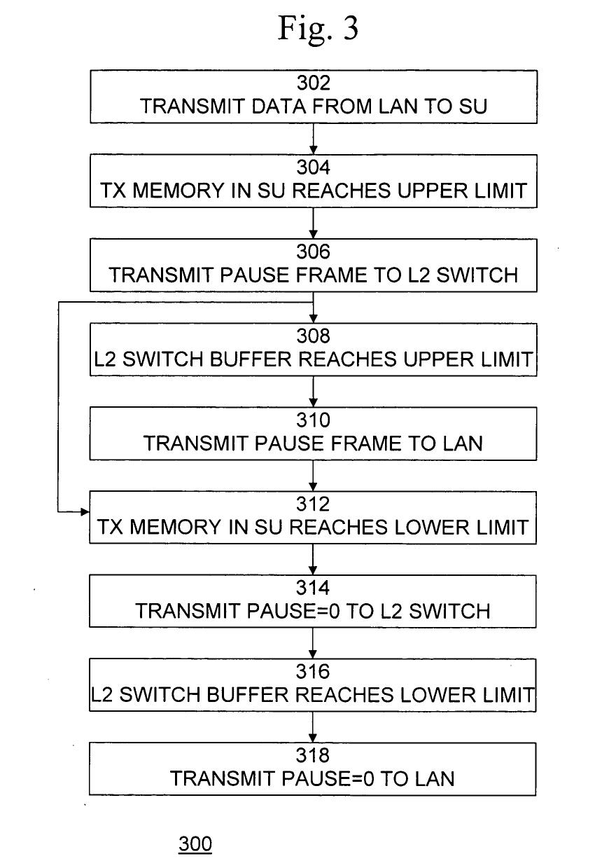

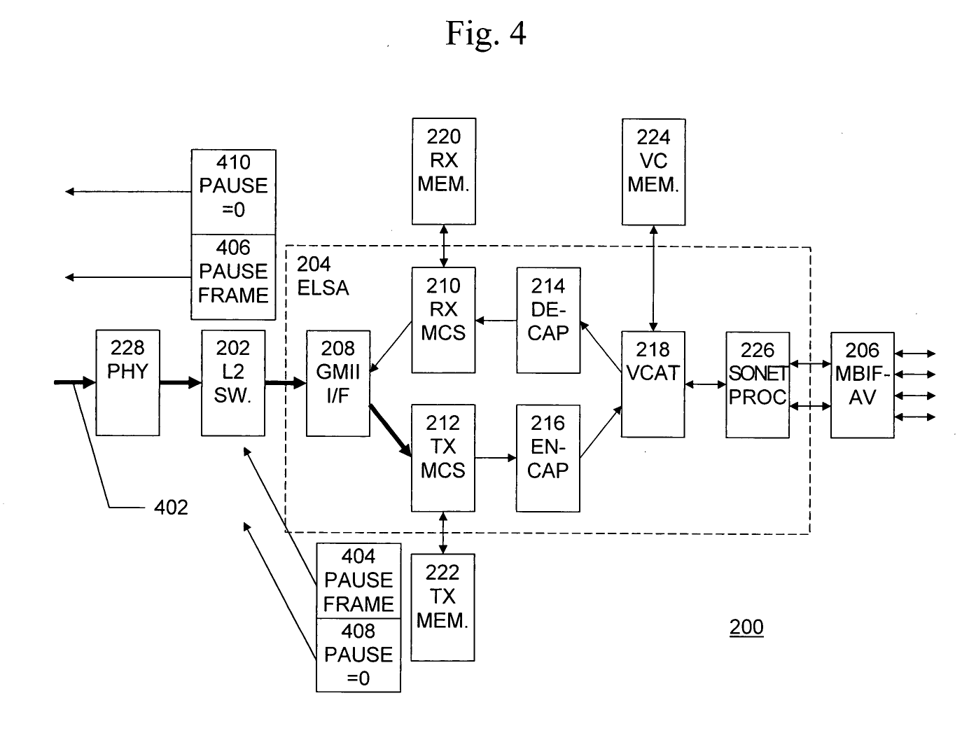

A process 300 of operation of SU 200, implementing rate limiting using PAUSE frames, is shown in FIG. 3. It is best viewed in conjunction with FIG. 4, which is a data flow diagram of data within SU 200. Process 300 begins with step 302, in which data 402 is transmitted from a LAN, such as Ethernet, to a SONET network via SU 200. The data is transmitted through PHY 228, L2 Switch 202, GMII interface 208, Tx MCS 212, Encapsulation block 216, VCAT block 218, SONET processing block 226, and MBIF-AV block 206. As the data is transmitted through SU 200, the data is buffered by Tx Memory 222 and by buffers included in L2 Switch 202. If the data throughput rate of the SONET channel connected to MBIF-AV block 206 is less than the data throughput rate of the LAN connected to PHY 228, the buffer in Tx Memory 222, in which the data is being buffered, may, in step 304 become “full”, where full is defined as reaching an upper limit or threshold of storage within Tx Memory 222.

If the upper storage limit within Tx Memory 222 is reached in step 304, then in step 306, a pause frame 404 is transmitted from Tx MCS 212 to L2 Switch 202. Upon receiving pause frame 404, L2 Switch 202 stops transmitting data to Tx MCS 212. With L2 Switch 202 not transmitting data, Tx Memory 222 begins to empty, while the buffers included in L2 Switch 202 begin to fill.

If there is a large data throughput mismatch, the buffers in L2 Switch 202 may, in step 308, themselves reach an upper limit or threshold of storage. If the upper storage limit of the buffers in L2 Switch 202 is reached in step 308, then, in step 310, a pause frame 406 is transmitted from L2 Switch 202 to the LAN through PHY 228. Upon receiving the pause frame, the LAN stops transmitting data to SU 200.

After step 310, with the LAN not transmitting data, L2 Switch 202 not transmitting data, and Tx Memory 222 emptying, in step 312, Tx Memory 222 will reach its lower limit. Likewise, after step 306, with L2 Switch 202 not transmitting data and Tx Memory 222 emptying, if the data throughput mismatch is not too large or too sustained, in step 312, Tx Memory 222 will reach its lower limit. In response, in step 314, a pause frame 408 with PAUSE=0 is transmitted from Tx MCS 212 to L2 Switch 202. Upon receiving pause frame 408 with PAUSE=0, L2 Switch 202 begins transmitting data to Tx MCS 212.

With L2 Switch 202 transmitting data, the buffers in L2 Switch 202 begin to empty. Eventually, in step 316, the buffers in L2 Switch 202 reach their lower limit. In response, a pause frame 410 with PAUSE=0 is transmitted from L2 Switch 202 to the LAN through PHY 228. Upon receiving pause frame 410 with PAUSE=0, the router/switch on the LAN begins transmitting data to SU 200.

A LAN Flow Control Relay is a mechanism, implemented within process 300, which allows an external buffer store to backpressure a layer 2 or layer 3 switch, such as L2 switch 202, shown in FIG. 2, through a standard GMII interface or other similar interface 208. The switch 202 must be able to support flow control on its own ports and when its internal buffers fill must be able to provide flow control (PAUSE frames or jam packets) to an external switch or router connected by a LAN connected to PHY 228, as in steps 308 and 310 of process 300. Many commercially available switch chips provide this mechanism. So, flow control can be handled in ELSA 204 and relayed through a switch device 202. This mechanism allows for a simple, elegant buffer management circuit without a lot of external circuitry. It allows the ELSA 204 to be portable across designs, should new, improved switch devices come to market. Preferably, flow control relay is implemented in systems using ELSA 204 in an FPGA or ASIC connected to a commercial off-the-shelf layer 2 switch 202. Attached to ELSA 204 is a large transmit memory 222. The depth of the frames stored in memory is monitored by ELSA 204. When the Tx memory 222 is nearly full, that is, it fills to a threshold level, ELSA 204 sends a PAUSE frame to the attached switch device through the GMII interface between ELSA 204 and L2 switch 202, as in step 304 and 306 of process 300. As in steps 308 and 310 or process 300, L2 switch 202 then fills its memory and when it reaches its threshold, sends a PAUSE frame to an external switch or router preventing further frames from being sent and relieving the memory congestion in the Tx memory 222 attached to ELSA 204.

In the example described above, the first PAUSE frame that is sent is sent with a value of 0×FFFF (hexadecimal). This is the maximum value possible. It is also possible to send the first PAUSE frame with a value less than this to lessen the PAUSE timer value of the sender. This may be useful for a case where the PAUSE=0 frame is never received and provides some fault tolerance within the system to allow traffic to be sent sooner in the absence of receiving the second pause frame.

It will be understood by those of skill in the art that other embodiments may be provided that provide similar advantages to the described embodiments. For example, it is desirable in many LAN Card designs implementing Ethernet Over SONET (EOS) to take all of the traffic that enters a service unit on an Ethernet port and pass it, without altering the data, to a WAN port. Many commercially available Layer 2 switch devices provide bridging functions, which filter Ethernet frames based on MAC Addresses and possibly other criteria. In many instances, these filtering mechanisms cannot be turned off and input data will be altered before reaching a WAN port. Port mirroring is a standard, which allows data on an input port to be sent to an output port for debug purposes. This mechanism can be used to pass all frames transparently through the switch without filtering any Ethernet frames. In effect, port mirroring transforms a layer 2 switch into a MAC device. This mechanism allows a dual purpose to a layer 2 switch that can be exploited in LAN card designs to implement two very different functions. The invention consists of programming a commercially available layer 2 switch in either port mirroring mode or standard bridging mode. This device connects to ELSA 204 or other suitable WAN encapsulation device which takes the data on the programmed output port and transports it via an appropriate encapsulation protocol.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A Local Area Network Service Unit comprising:
a first device having a Local Area Network interface and a second interface, the first device operable to perform MAC level operation, statistics gathering, and bridging functions; and
a second device having a Wide Area Network interface and a second interface to the second interface of the Layer 2 switch, the second device operable to perform Wide Area Network data encapsulation and decapstilation and transmit and receive buffering.

2. The Service Unit of claim 1, wherein the Local Area Network interface comprises an Ethernet interface.

3. The Service Unit of claim 2, wherein the Local Area Network interface comprises a 10/100BaseT or GigE Ethernet interface.

4. The Service Unit of claim 3, further comprising a physical layer device connected to the Local Area Network interface and operable to provide optical or electrical interfaces operating at 10/100BaseT or GigE speeds.

5. The Service Unit of claim 4, wherein the Wide Area Network interface comprises a Synchronous Optical Network interface or a Synchronous Digital Hierarchy interface.

6. The Service Unit of claim 5, wherein the second device is operable to perform Synchronous Optical Network or Synchronous Digital Hierarchy data encapsulation and decapsulation.

7. The Service Unit of claim 6, wherein the second device comprises a Field Programmable Gate Array or an Application-Specific Integrated Circuit.

8. The Service Unit of claim 6, wherein the second interface of the Layer 2 switch and the second interface of the second device comprises a GMII interface.

9. The Service Unit of claim 6, wherein the first device comprises a Layer 2 switch.

10. The Service Unit of claim 9, wherein the Layer 2 switch is placed in a port mirroring mode and is operable to provide transparency to frames except PAUSE frames.

11. The Service Unit of claim 6, wherein the first device comprises a network processor.

12. The Service Unit of claim 1, further comprising a transmit memory buffer and a receive memory buffer connected to the second device and wherein the first device comprises an internal memory buffer.

13. The Service Unit of claim 12, wherein the second device is further operable to determine when the transmit memory buffer has filled to a threshold level and, in response, to transmit flow control information to the first device.

14. The Service Unit of claim 13, wherein the first device is further operable to determine when the internal memory buffer has filled to a threshold level and, in response, to transmit flow control information via the Local Area Network interface.

15. The Service Unit of claim 14, wherein the flow control information comprises a PAUSE frame.

16. The Service Unit of claim 15, wherein the PAUSE frame has a value less than the maximum value.

17. The Service Unit of claim 15, wherein the Local Area Network interface comprises an Ethernet interface.

18. The Service Unit of claim 17, wherein the Local Area Network interface comprises a 10/100BaseT or GigE Ethernet interface.

19. The Service Unit of claim 18, further comprising a physical layer device connected to the Local Area Network interface and operable to provide optical or electrical interfaces operating at 10/100BaseT or GigE speeds.

20. The Service Unit of claim 19, wherein the Wide Area Network interface comprises a Synchronous Optical Network interface or a Synchronous Digital Hierarchy interface.

21. The Service Unit of claim 20, wherein the second device is operable to perform Synchronous Optical Network or Synchronous Digital Hierarchy data encapsulation and decapsulation.

22. The Service Unit of claim 21, wherein the second device comprises a Field Programmable Gate Array or an Application-Specific Integrated Circuit.

23. The Service Unit of claim 22, wherein the second interface of the first device and the second interface of the second device comprise a GMII interface.

24. The Service Unit of claim 23, wherein the first device comprises a Layer 2 switch.

25. The Service Unit of claim 24, wherein the Layer 2 switch is placed in a port mirroring mode and is operable to provide transparency to frames except PAUSE frames.

26. The Service Unit of claim 23, wherein the first device comprises a network processor.
